(19) United States
(12) Patent Application Publication
(10) Pub. No.: US 2023/0185077 A1
(43) Pub. Date: Jun. 15, 2023

(54) OPTICAL ELEMENT AND METHOD FOR OPERATING AN OPTICAL ELEMENT

(71) Applicant: Nextlens Switzerland AG, Dietikon (CH)

(72) Inventors: Stephan SMOLKA, Dietikon (CH); Johannes HAASE, Dietikon (CH)

(73) Assignee: Nextlens Switzerland AG, Dietikon (CH)

(21) Appl. No.: 18/065,630

(22) Filed: Dec. 14, 2022

(30) Foreign Application Priority Data
Dec. 14, 2021 (DE) 102021133154.4

(51) Int. Cl. G02B 26/00; G02B 7/18; G02B 26/08; H02N 10/00; F03G 7/06

(52) U.S. Cl. CPC G02B 26/004; G02B 7/1815; G02B 26/0883; H02N 10/00; F03G 7/06143

(57) ABSTRACT

Optical element (1) comprising a first window (21) and a second window (22), wherein the first window (21) is connected to the second window (22) by an elastic membrane (41) such that the first window (21), the second window (22) and the membrane (41) enclose a deformable, sealed volume (42), which is filled with a fluid, wherein at least one first actuator (51) is arranged to tilt the first window (21) with respect to the second window (22) around a first tilting axis (81) in a first direction, wherein the first actuator (51) comprises a Shape Memory Alloy and has the shape of a wire.

### CROSS REFERENCE TO RELATED APPLICATIONS

Benefit is claimed to German Patent Application No. DE102021133154.4, filed Dec. 14, 2021, the contents of which are incorporated by reference herein in their entirety.

### FIELD

The optical element described here and in the following is an optical element with a controlling element for tilting a window of the optical element and a method for tilting.

### BACKGROUND

In a conventional optical element, a VCM actuator is used for tilting a window of a prism. The VCM actuator comprises a heavy magnet. The heaviness can cause severe compression, deformation, or breakage of the prism, glass, or shaper during drop tests.

### SUMMARY

The optical element comprises a first window and a second window. In particular, the first window and the second window each form an optical surface of the optical element. For example, light interacting with the optical element in an intended manner is refracted at said optical surfaces. The first window and the second window comprise a material which is transparent for electromagnetic radiation in the visible wavelength range. In particular, the first window and the second window may comprise glass, acrylic or fluorite. In particular, the material of the first window and the second window may be different.

The optical element comprises a sealed volume, which is completely enclosed by solids in a fluid-tight manner. Along the optical axis, the sealed volume is delimited by the first window and the second window. Here and in the following, it is assumed that an optical axis extends perpendicular to the main extension planes of the first and the second window in an undeflected state. In particular, in a tuning state of the optical element where the first window and the second window extend parallel with respect to each other, the optical axis extends perpendicular to the main extension planes of the first and the second window and lateral directions extend perpendicular with respect to the optical axis.

The optical element comprises a membrane, which is a thin, elastic solid, which is arranged to enclose a fluid. The membrane encloses the sealed volume in lateral directions. Here and in the following, lateral directions are directions which neither pass the first window nor the second window. Alternatively, the membrane encloses the sealed volume in directions perpendicular to lateral directions, too. According to this alternative, the membrane is arranged between the sealed volume and the first window, and the membrane is arranged between the sealed volume and the second window. In particular, the membrane encapsulates the sealed volume completely on all sides. In particular, the membrane comprises a material which is transparent for electromagnetic radiation in the visible wavelength range.

Here and in the following, the assembly of the first window, the second window and the membrane is called prism. In particular, this assembly is called tunable prism.

The sealed volume is deformable. The sealed volume comprises a fluid material, wherein a shape of the fluid material may be altered when deforming the sealed volume. In particular, the sealed volume is deformable by tilting the first window with respect to the second window. The sealed volume may be deformable by tilting the second window with respect to the first window. In particular, the sealed volume may be deformable by tilting the first window and the second window. The first window and the second window each are tiltable. In particular, the first window is tiltable around a first tilting axis and the second window is tiltable around a second tilting axis. The first tilting axis extends parallel to a main extension plane of the first window. In particular, the first tilting axis extends along a first geometric axis of the sealed volume as seen in a top view along an optical axis of the optical element. More particular or alternatively, the first tilting axis extends along the first interface of the first window and the sealed volume. Here and in the following, the first interface is defined by the area where the first window delimits the sealed volume, or the first interface is defined by the area where the first window is extensively connected to the membrane.

The second tilting axis extends parallel to a main extension plane of the second window. In particular, the second tilting axis extends along a second geometric axis of the sealed volume as seen in a top view along an optical axis of the optical element. More particular or alternatively, the second tilting axis extends along the second interface of the second window and the sealed volume. Here and in the following, the second interface is defined by the area where the second window delimits the sealed volume, or the second interface is defined by the area where the second window is extensively connected to the membrane.

The second tilting axis extends obliquely with respect to the first tilting axis. In particular, the second tilting axis extends 90° with respect to the first tilting axis. In particular, the first tilting axis is associated with the axis for the x-tilt and the second tilting axis is associated with the axis for the y-tilt. Hence, the first window is arranged to tilt around the x-axis and the second window is arranged to tilt around the y-axis. Alternatively, the first tilting axis is associated with the axis for the y-tilt and the second tilting axis is associated with the axis for the x-tilt leading to an arrangement for the first window to tilt around the y-axis and for the second window to tilt around the x-axis.

In particular, the first tilting axis is extending through an attachment point provided by a mount and the second tilting axis is extending through another attachment point provided by the mount. Here and in the following, the mount is a solid holding the prism in a cut out of the mount. In particular, the mount may be a Printed Circuit Board. More particular, the mount acts as a spacer keeping the first window and the second window at a distance to each other such that the prism cannot be compressed in a direction along the optical axis below a minimal distance between the first and the second window. Even more particular, the mount extends perimetrically around the sealed volume as seen in top view, along the optical axis of the prism. Additionally, the first tilting axis is extending through a top shaper and the second tilting axis is extending through a bottom shaper. Here and in the following, the top shaper is a solid structure that is exclusively connected to the first window and frames the first window as seen in a top view along an optical axis of the optical element and the bottom shaper is a solid structure that is exclusively connected to the second window and frames the second window as seen in a bottom view along an optical axis of the optical element. In particular, the prism comprises the top shaper and the bottom shaper. Even more particular, the bottom shaper comprises the Printed Circuit Board.

In particular, the one or more attachment points provided by the mount are bearings. Hence, the first tilting axis is extending through one bearing provided by the mount and the second tilting axis is extending through another bearing provided by the mount. More particular, the first tilting axis is extending through two bearings provided by the mount and the second tilting axis is extending through another two bearings provided by the mount.

Alternatively, the first tilting axis extends through a first attachment point of the first actuator to the top shaper and the second tilting axis extends through a second attachment point of the second actuator to the bottom shaper.

At least one first actuator is arranged to tilt the first window with respect to the second window around a first tilting axis in a first direction. In particular, the optical element comprises at least one first resetting element. The first resetting element is arranged to tilt the first window in a first counter direction, wherein the first counter direction is opposed to the first direction. In particular, at least one second actuator is arranged to tilt the second window with respect to the first window around a second tilting axis in a second direction. More particular, the optical element comprises at least one second resetting element. The second resetting element is arranged to tilt the second window in a second counter direction, wherein the second counter direction is opposed to the second direction. Hence, the first actuator and the second actuator each comprise a protagonistic force, while the first resetting element and the second resetting element each comprise anantagonistic force.

The present optical element is based on the following considerations. Due to a raised pressure in the sealed volume optical elements with a fluid inside are prone to be damaged and to fail. In conventional optical elements acceleration forces, especially in a drop test, result in an increased pressure in the sealed volume. In a tunable prism, the acceleration forces cause, supported by the weight of the at least one actuator, the first window and the second window to accelerate toward each other, creating increased pressure in the sealed volume of fluid between them. Due to the increased pressure the membrane and/or the windows experience high stress, which may destroy the optical element eventually.

The present optical element makes use of the idea to prevent damage of the windows or the membrane when applying a force to the optical element by decreasing the weight of the at least one actuator for tilting a window in the prism.

In a conventional optical element a VCM actuator is used for tilting a window of a prism. The VCM actuator comprises a heavy magnet. The heaviness can cause severe compression, deformation, or breakage of the prism, glass, or shaper during drop tests.

Advantageously, the at least one first actuator of the present optical element comprises a Shape Memory Alloy. Here and in the following, the Shape Memory Alloy is an alloy which contracts when heated up above a certain transition temperature. An element comprising a Shape Memory Alloy has a strong force and features a small weight. However, an element comprising the Shape Memory Alloy may only provide pulling forces along its main extension direction.

Above all, the low weight ensures that the element comprising the Shape Memory Alloy performs well in a reliability test. The optical element has less moving mass in a drop test, so the prism is less likely to fail. Thus, the prism is more shock test resistant. Further, an optical element comprising the Shape Memory Alloy comprises a lean design.

In particular, an element with the Shape Memory Alloy comprises the functionality of a length sensor. Due to the fact that heating above a certain transition temperature leads to a contraction of the element with the Shape Memory Alloy, the resistance of the element in each expansion state may be used to measure the amount of contraction.

At least one first actuator is arranged to tilt the first window with respect to the second window around a first tilting axis in a first direction. The first actuator comprises the Shape Memory Alloy and is formed in the shape of a wire. This actuator features less weight compared to a VCM actuator used in a conventional optical element. In particular, the first actuator in form of a wire makes the prism more shock resistant in a drop test, when the prism is hanging in the mount and is only attached by the wires. Thus, the risk for damaging the membrane, the first window or the second window due to acceleration forces is reduced.

The heating of the first actuator in form of a Shape Memory Alloy wire leads to a contraction along its main extension direction by at least 2%, preferably by at least 3%, when exceeding the transition temperature. The first actuator in form of a Shape Memory Alloy wire changes its phase at a transition temperature of 80° C., preferably 90° C. While a contraction of the first actuator takes place when the transition temperature is exceeded, an expansion of the first actuator takes place when the transition temperature is deceeded. Thus, the first actuator contracts above the transition temperature and expands when cooled down below the transition temperature.

In particular, the first actuator connects the bottom shaper and the top shaper.

More particular, the first actuator in form of the Shape Memory Alloy wire acts as a damping spring or alternatively as a hard end stop. Thus, the first actuator damps or alternatively stops the relative movement of the first window towards the second window. Even more particular, the first actuator in form of the Shape Memory Alloy wire is down-scalable. In particular, the assembly MP process using a wire bonder may be used (wire bonding).

According to one embodiment, the optical element comprises at least one first resetting element.

The first resetting element is arranged to tilt the first window in a first counter direction, wherein the first counter direction is opposed to the first direction. Thus, the first resetting element features an antagonistic force. The first resetting element comprises the Shape Memory Alloy and has the shape of a wire. In a conventional prism a VCM actuator tilts the first window in opposite direction in which it was previously tilted. The first resetting element in the shape of a wire makes the first resetting element less heavy compared to the conventional VCM actuator. The first resetting element in form of the Shape Memory Alloy wire leads to a faster response of the prism during cooling phase of the first actuator. When the first resetting element acts, the first actuator comprising the Shape Memory Alloy is cooling down deceeding the transition temperature. Alternatively, the first resetting element may act, when the first actuator comprising the Shape Memory Alloy has already been cooled down.

According to one embodiment, the first tilting axis extends parallel to a main extension plane of the first window and along a first geometric axis of the sealed volume as seen in a top view along an optical axis of the optical element. Alternatively, the first tilting axis extends parallel to a main extension plane of the first window and through a first attachment point of the first actuator with a top shaper. The top shaper is connected to the first window.

According to one embodiment, at least one second actuator is arranged to tilt the second window with respect to the first window around a second tilting axis in a second direction. The second actuator comprises the Shape Memory Alloy and has the shape of a wire.

According to one embodiment, at least one second resetting element is arranged to tilt the second window in a second counter direction, wherein the second counter direction is opposed to the second direction. The second resetting element comprises the Shape Memory Alloy and has the shape of a wire. When the second resetting element acts, the second actuator comprising the Shape Memory Alloy is cooling down deceeding the transition temperature. Alternatively, the second resetting element may act, when the second actuator comprising the Shape Memory Alloy has already been cooled down.

According to one embodiment, the optical element comprises a second tilting axis. The second tilting axis extends obliquely with respect to the first tilting axis. In particular, the second tilting axis extends 90° with respect to the first tilting axis. The second tilting axis extends along a main extension plane of the second window and along a geometric axis of the sealed volume as seen in a top view along an optical axis of the optical element. Alternatively, the second tilting axis extends along a main extension plane of the second window and through a second attachment point of the second actuator to a bottom shaper. The bottom shaper is connected to the second window.

According to one embodiment, the optical element comprises a third resetting element. The third resetting element is arranged to tilt the first window in a third counter direction, wherein the third counter direction is opposed to the first direction. Alternatively, the third resetting element is arranged to tilt the second window in a fourth counter direction, wherein the fourth counter direction is opposed to the second direction. In another alternative, the third resetting element is arranged to tilt the first window in a third counter direction with the third counter direction being opposed to the first direction and to tilt the second window in a fourth counter direction with the fourth counter direction being opposed to the second direction. In particular, the third resetting element comprises the elastic membrane. Thus, the membrane features an antagonistic force. The antagonistic force is generated by elastic deformation of the elastic membrane. In particular, the elastic membrane may be deformed by means of an increase in pressure within the sealed volume.

Alternatively, the third resetting element comprises at least one resetting spring. Thus, the resetting spring features an antagonistic force. In particular, the resetting spring is a circumferential leaf spring. In particular, the resetting spring is an individual coil spring. In another alternative, the third resetting element comprises at least one resetting magnet. Thus, the resetting magnet features an antagonistic force. In particular, the resetting magnet is a repelling magnet. More particular, the repelling magnet is arranged at the bottom shaper. A corresponding counterpart is arranged at the top shaper such that a repelling force is created between the top shaper and the bottom shaper. The corresponding counterpart may be one or more counter-magnets. Alternatively, the third resetting element may comprise the membrane, the resetting spring and the resetting magnet or in a further alternative a combination of it.

Hence, the third resetting element is arranged to tilt either the first window, the second window, or both windows in the opposite direction in which they were previously tilted. Thus, the third resetting element comprises an antagonistic force. When the third resetting element acts, the first actuator and the second actuator each cool down deceeding the transition temperature. Alternatively, the third resetting element may act, when the first actuator and the second actuator have already been cooled down.

According to one embodiment, the optical element comprises a mount. The mount provides at least one first bearing for the top shaper to define the first tilting axis. Alternatively, the mount provides at least one second bearing for the bottom shaper to define the second tilting axis. In another alternative, the mount provides at least one first bearing for the top shaper to define the first tilting axis and at least one second bearing for the bottom shaper to define the second tilting axis. The mount may be a Printed Circuit Board. The Printed Circuit Board has the advantage of a simplified electrical connection to the Shape Memory Alloy wires. However, the mount may also be of any other kind of structure which provides sufficient mechanical stability and allows electrical connection of the Shape Memory Alloy wires.

In particular, the mount, especially the Printed Circuit Board, is connected to the prism by the first actuator. In particular, the second actuator connects the mount, especially the Printed Circuit Board, to the prism. More particular, the first actuator and the second actuator connect the mount, especially the Printed Circuit Board, to the prism. Especially, the Printed Circuit Board is arranged to interface the Shape Memory Alloy wire.

According to one embodiment, the top shaper and the bottom shaper are connected by the first actuator. Alternatively, the top shaper and the bottom shaper are connected by the second actuator.

A method for operating an optical element is also specified. In particular, an optical element described here can be operated with the method. This means that all the features disclosed for the optical element are also disclosed for the method and vice versa.

The method for operating an optical element is based on an optical element comprising a first window, a second window and a membrane. The first window, the second window and the membrane enclose a sealed volume, which is filled with a fluid. A first actuator comprises a Shape Memory Alloy, thus, features a transition temperature. The optical element is operated such, that the first actuator comprising the Shape Memory Alloy is heated up by supplying current. Once a transition temperature is reached, the first actuator contracts, and the contraction tilts the first window with respect to the second window around a first tilting axis in a first direction.

According to one embodiment, a second actuator comprises the Shape Memory Alloy, thus, features a transition temperature. The optical element is operated such, that the second actuator comprising the Shape Memory Alloy is heated up by supplying current. Once a transition temperature is reached, the second actuator contracts, and the contraction tilts the second window with respect to the first window around a second tilting axis in a second direction.

According to one embodiment, the transition temperature of the first actuator is 80° C., preferably 90° C. Exceeding the transition temperature the first actuator contracts along its main extension direction by at least 2%, preferably by at least 3%. Alternative, the transition temperature of the second actuator is 80° C., preferably 90° C. Exceeding the transition temperature the second actuator contracts along its main extension direction by at least 2%, preferably by at least 3%. In another alternative, the first actuator and the second actuator contract along their main extension directions by at least 2%, preferably by at least 3%, when the transition temperatures, which are 80° C., preferably 90° C., are exceeded.

According to one embodiment, the optical element is operated such, that the first actuator cools down deceeding the transition temperature. A third resetting element tilts the first window in a third counter direction with the third counter direction being opposed to the first direction. Alternative, the optical element is operated such, that the second actuator cools down deceeding the transition temperature. The third resetting element tilts the second window in a fourth counter direction with the fourth counter direction being opposed to the second direction. In another alternative, the optical element is operated such, that the first actuator and the second actuator each cool down deceeding the transition temperature. The third resetting element tilts the first window in the third counter direction and tilts the second window in a fourth counter direction.

According to one embodiment, the optical element is operated such, that the first actuator cools down deceeding the transition temperature. A first resetting element is heated up by supplying current. Once a transition temperature is reached, the first resetting element contracts. The contraction of the first resetting element tilts the first window in a first counter direction with the first counter direction being opposed to the first direction. Alternative, the optical element is operated such, that the second actuator cools down deceeding the transition temperature. A second resetting element is heated up by supplying current. Once a transition temperature is reached, the second resetting element contracts. The contraction of the second resetting element tilts the second window in a second counter direction with the second counter direction being opposed to the second direction. In another alternative, the optical element is operated such, that the first actuator and the second actuator each cool down deceeding the transition temperature. The first resetting element and the second resetting element are heated up by supplying current. Once a transition temperature is reached, the first resetting element contracts and once a transition temperature is reached, the second resetting element contracts. The contraction of the first resetting element and the contraction of the second resetting element tilts the first window in a first counter direction and tilt the second window in a second counter direction.

### BRIEF DESCRIPTION OF THE DRAWINGS

Further advantages and applied refinements and developments of the optical element and the method for operating an optical element emerge from the following exemplary embodiments illustrated in connection with the Figures.

FIG. 1 shows a first exemplary embodiment of an optical element with an actuator to tilt the first window around a first tilting axis;

FIG. 2 shows the first exemplary embodiment of an optical element in its deflected state, where the first window has been tilted;

FIG. 3 shows a second exemplary embodiment of an optical element comprising the features of the first exemplary embodiment with a third resetting element;

FIG. 4 shows a third exemplary embodiment of an optical element comprising the features of the first exemplary embodiment with yet another third resetting element;

FIG. 5 shows a fourth exemplary embodiment of an optical element comprising the features of the first exemplary embodiment with another third resetting element;

FIG. 6 shows a fifth exemplary embodiment of an optical element comprising the features of the first exemplary embodiment with a first resetting element;

FIG. 7 shows a six exemplary embodiment of an optical element, where one first actuator and one first resetting element is on the same side of the prism;

FIG. 8 shows the six exemplary embodiment of an optical element in its deflected state, where the first window has been tilted and where one first actuator and one first resetting element is on the same side of the prism;

FIG. 9-11 shows a seven exemplary embodiment of an optical element, where two first actuators are on one side of the prism and two first resetting elements are both on the other side of the prism;

FIG. 12 shows an eight exemplary embodiment of an optical element, where four first actuators and four first resetting elements are tilting the first window around two different first tilting axes.

### DETAILED DESCRIPTION

Identical, similar or identically acting elements are provided with the same reference symbols in the figures. The figures and the proportions of the elements shown in the figures among one another are not to be considered to scale, unless units are expressly stated. Rather, individual elements can be shown in an exaggerated size for better representation and/or for better comprehensibility.

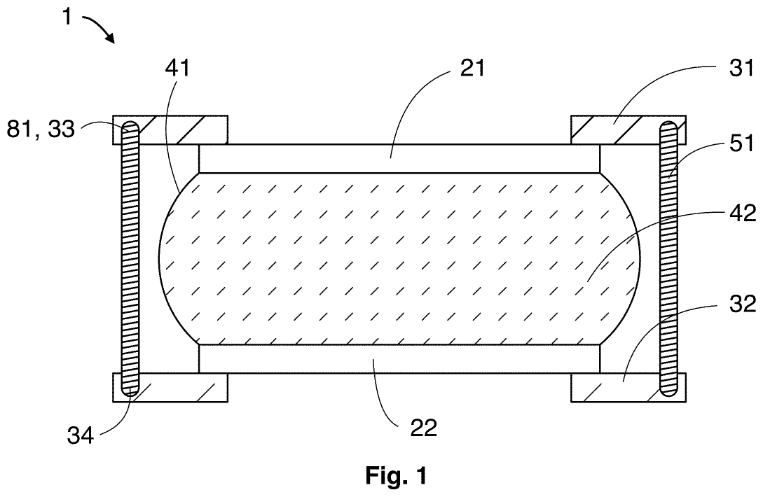

FIG. 1 shows an exemplary embodiment of an optical element 1 in a schematic sectional view, comprising a first window 21, a second window 22 and a membrane 41. The first window 21 is connected to the second window 22 by the elastic membrane 41. The connection is such that the first window 21, the second window 22 and the membrane 41 enclose a sealed volume 42. The sealed volume 42 is filled with a fluid. The fluid may be a liquid or a gas. The membrane 41 encloses the sealed volume 42 in lateral directions. In one of the directions perpendicular to lateral directions the sealed volume 42 is delimited by the first window 21, whereas in an opposite direction the sealed volume 42 is delimited by the second window 22. In the embodiment of FIG. 1 the first window 21 and the second window 22 delimit the sealed volume 42 on opposite sides. Alternatively, the membrane 41 may enclose the entire sealed volume 42, meaning the membrane 41 encloses the sealed volume 42 in lateral directions and in directions perpendicular to lateral directions. Thus, according to the alternative the first window 21 and the second window 22 are attached extensively to the membrane 41. In particular, in case the membrane 41 encloses the sealed volume 42 completely on all sides, the first window 21 and the second window 22 are arranged to stiffen the membrane 41.

The first window 21 as well as the second window 22 are tiltable. Each window 21, 22 can be tilted separately by an actuator. The first window 21 is tiltable around a first tilting axis 81, whereas the second window 22 is tiltable around a second tilting axis 82. At least one first actuator 51 is arranged to tilt the first window 21. In FIG. 1 two first actuators 51 are shown. At least one second actuator 52 is arranged to tilt the second window 22. The second actuator 52 is not shown in FIG. 1. The first actuator 51 tilts the first window 21 with respect to the second window 22 around a first tilting axis 81 in a first direction, whereas the second actuator 52 tilts the second window 22 with respect to the first window 21 around a second tilting axis 82 in a second direction.

The first tilting axis 81 extends parallel to a main extension plane of the first window 21. In addition, in FIG. 1, the first tilting axis 81 extends through a first attachment point 33 of the first actuator 51 to a top shaper 31. The top shaper 31 is connected to the first window 21. Alternatively, the first tilting axis 81 extends along a first geometric axis 91 of the sealed volume 42 as seen in a top view along an optical axis of the optical element 1. The second tilting axis 82 extends parallel to a main extension plane of the second window 22. In addition, the second tilting axis 82 extends through a second attachment point 34 of the second actuator 52 to a bottom shaper 32. The bottom shaper 32 is connected to the second window 22. Alternatively, the second tilting axis 82 extends along a second geometric axis 92 of the sealed volume 42 as seen in a top view along an optical axis of the optical element 1. The second tilting axis 82 is not shown in FIG. 1. The first tilting axis 81 and the second tilting axis 82 extend oblique to each other. In FIG. 1, the first tilting axis 81 and the second tilting axis 82 extend 90° to each other. The first tilting axis 81 for tilting the first window 21 is associated with the x-axis, whereas the second tilting axis 82 for tilting the second window 22 is associated with the y-axis. Alternatively, the first tilting axis 81 for tilting the first window 21 is associated with the y-axis, whereas the second tilting axis 82 for tilting the second window 22 is associated with the x-axis.

The first actuator 51 comprises a Shape Memory Alloy and the second actuator 52 comprises a Shape Memory Alloy as well. The Shape Memory Alloy has the advantage that a movement can be executed by just heating up the element comprising the Shape Memory Alloy. Typically, the heating will be performed by supplying current. Above a certain transition temperature, the element comprising the Shape Memory Alloy contracts. The first actuator 51 has the shape of a wire and the second actuator 52 has the shape of a wire, too. Heating an element comprising the Shape Memory Alloy and having a shape of a wire leads to a contraction along its main extension direction by at least 2%, preferably by at least 3%. Typically wires with a Shape Memory Alloy change their phase at a transition temperature of 80° C., preferably 90° C. So, the first actuator 51 contracts along its main extension direction by at least 2%, preferably by at least 3%, when heated up above 80° C., preferably 90° C., and the second actuator 52 contracts along its main extension direction by at least 2%, preferably by at least 3%, when heated up above 80° C., preferably 90° C.

Particular in the embodiment of FIG. 1, the top shaper 31 and the bottom shaper 32 are connected by the first actuator 51, especially by the two first actuators 51.

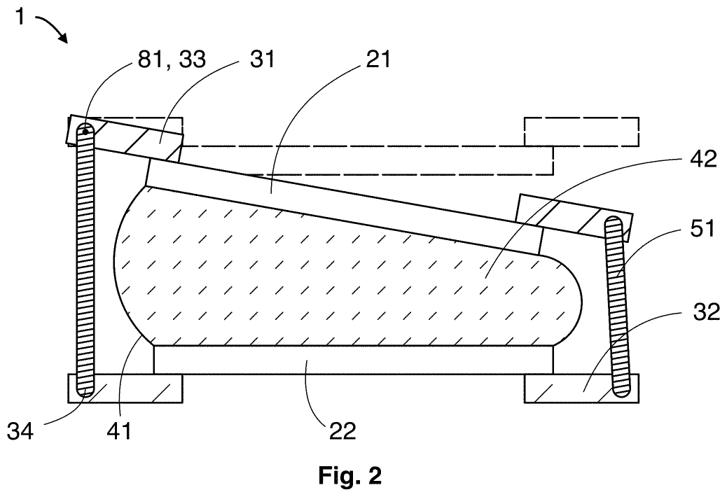

FIG. 2 shows the exemplary embodiment of an optical element 1 of FIG. 1 in a schematic sectional view, in which the first window 21 is tilted. This exemplary embodiment having a first window 21, a second window 22 and a membrane 41 comprises a sealed volume 42, which is deformed. The deformation of the sealed volume 42 has been taken place due to tilting the first window 21 around the first tilting axis 81 with respect to the second window 22. The first tilting axis 81 extends parallel to a main extension plane of the first window 21 and through a first attachment point 33 of the first actuator 51 to the top shaper 31.

The tilting of the first window 21 has been taken place by the first actuator 51. The first actuator 51 has the shape of a wire and comprises the Shape Memory Alloy. By supplying current, the first actuator 51 has been heated to 80° C., preferably 90° C. At a temperature of 80° C., preferably 90° C., the first actuator 51 had reached the transition temperature. Once the transition temperature has been exceeded the first actuator 51 has started to contract. The first actuator 51 has been contracted along its main extension direction by at least 2%, preferably by at least 3%.

The heating of the first actuator 51 leads to a protagonistic force, which tilts the first window 21 around the first tilting axis 81. The embodiment of the optical element 1 in FIG. 2 as well as in FIG. 1 comprises a third resetting element 63. The third resetting element 63 leads to an antagonistic force, which acts opposite to the said protagonistic force. The third resetting element 63 is arranged to tilt the first window 21 in a third counter direction, wherein the third counter direction is opposed to the first direction and, if the second window 22 is tilted as well, the third resetting element 63 is arranged to tilt the second window 22 in a fourth counter direction, wherein the fourth counter direction is opposed to the second direction.

In FIG. 2, the third resetting element 63 comprises the elastic membrane 41, which encloses together with the first window 21 and the second window 22 the sealed volume 42. The elastic membrane 41 comprises the antagonistic force in order to tilt the first window 21 in the third counter direction.

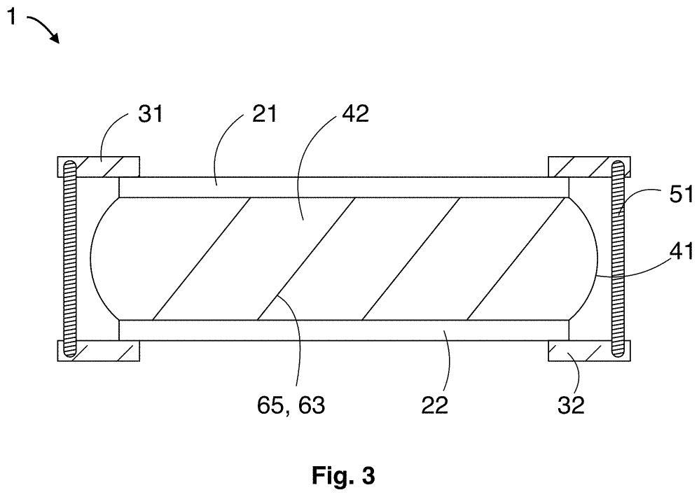

FIGS. 3-6 each show an exemplary embodiment of an optical element 1 in a schematic sectional view. In the exemplary embodiments neither of the two windows 21, 22 are tilted. Each exemplary embodiment of the optical element 1 comprises all the features of the exemplary embodiment of the optical element 1 of FIG. 1. Thus, each embodiment comprises a first window 21, a second window 22 and a membrane 41, which, all three, enclose a sealed volume 42. Each embodiment also comprises two first actuators 51 which connect the top shaper 31 to the bottom shaper 32 and tilt the first window 21 around a first tilting axis 81.

When the first window 21 is tilted as needed, the first actuator 51 cools down deceeding the transition temperature. When the second window 22 is tilted as needed, the second actuator 52 cools down deceeding the transition temperature. After the first actuator 51 has been cooled down or while the first actuator 51 is cooling down the third resetting element 63 tilts the first window 21 in a third counter direction with the third counter direction being opposed to the first direction. After the second actuator 52 has been cooled down or while the second actuator 52 is cooling down the third resetting element 63 tilts the second window 22 in a fourth counter direction with the fourth counter direction being opposed to the second direction.

In FIG. 3, a third resetting element 63 comprises at least one resetting spring 65. Here, the resetting spring 65 comprises a circumferential leaf. The circumferential leaf comprises the antagonistic force in order to tilt the first window 21 in the third counter direction and/or to tilt the second window 22 in the fourth counter direction.

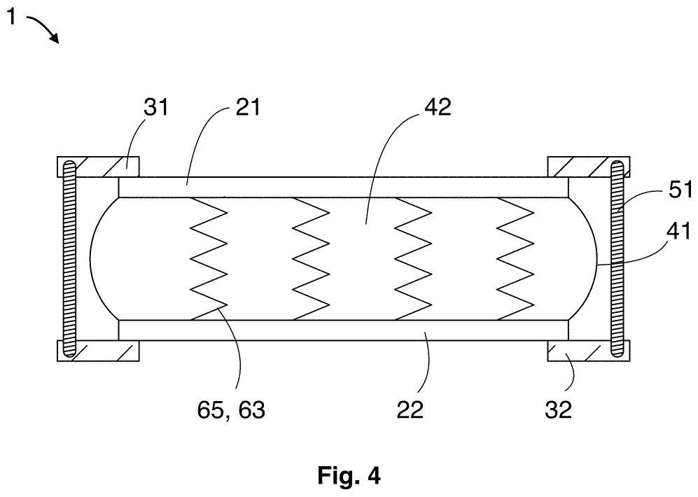

In FIG. 4, a third resetting element 63 comprises at least one resetting spring 65. Here, the resetting spring 65 comprises an individual coil spring. The individual coil spring comprises the antagonistic force in order to tilt the first window 21 in the third counter direction and/or to tilt the second window 22 in the fourth counter direction.

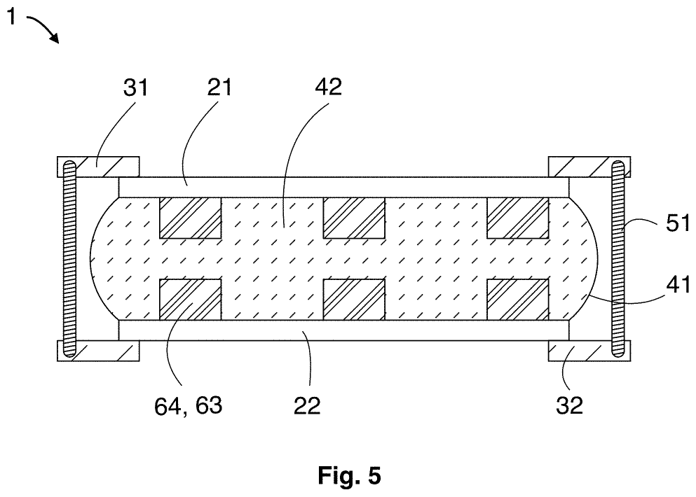

In FIG. 5, a third resetting element 63 comprises at least one resetting magnet 64. Here, the resetting magnet 64 comprises a repelling magnet. The repelling magnet comprises the antagonistic force in order to tilt the first window 21 in the third counter direction and/or to tilt the second window 22 in the fourth counter direction.

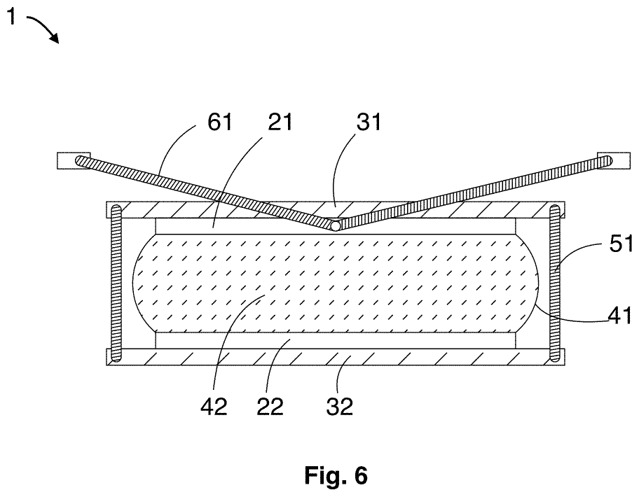

In FIG. 6, a first resetting element 61 comprises the antagonistic force and is arranged to tilt the first window 21 in the third counter direction. The first resetting element 61 is only arranged to tilt the first window 21 in the third counter direction and not arranged to tilt the second window 22 in the fourth counter direction. The first resetting element 61 comprises the Shape Memory Alloy. So, heating the first resetting element 61 above a certain transition temperature leads to a contraction of the first resetting element 61. The first resetting element 61 has the shape of a wire, so the transition temperature is reached by 80° C., preferably by 90° C. At this temperature and above the first resetting element 61 starts to change its phase and contracts. The contraction leads to tilting the first window 21 in the third counter direction. The heating is provided by supplying current to the first resetting element 61.

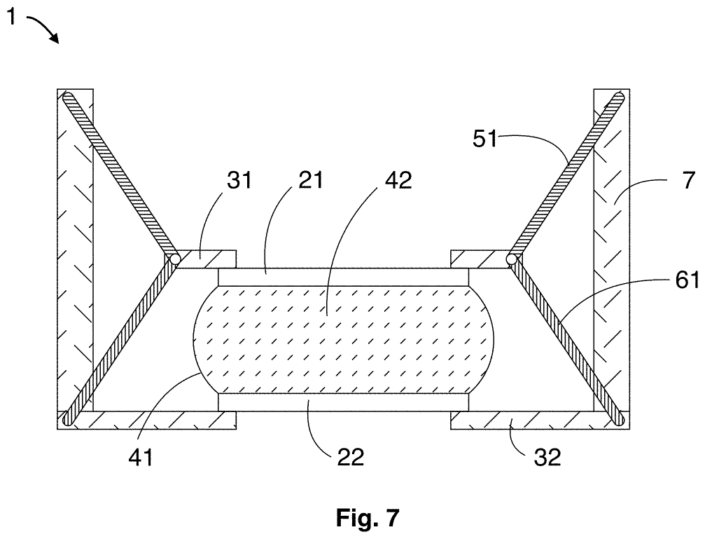

FIG. 7 shows another exemplary embodiment of an optical element 1 in a schematic sectional view. The exemplary embodiment in FIG. 7 comprises a first window 21, a second window 22 and a membrane 41, which, all three, enclose a sealed volume 42. The exemplary embodiment in FIG. 7 comprises two first actuators 51 to tilt the first window 21 around a first tilting axis 81 in a first direction. The exemplary embodiment in FIG. 7 comprises two first resetting elements 61 to tilt the first window 21 in the third counter direction with the third counter direction being opposed to the first direction.

Whereas in the exemplary embodiments of FIGS. 1 to 6 the first tilting axis 81 extends parallel to a main extension plane of the first window 21 and through a first attachment point 33 of the first actuator 51 to a top shaper 31, the first tilting axis 81 of the exemplary embodiment in FIG. 7 extends parallel to a main extension plane of the first window 21 and along a first geometric axis 91 of the sealed volume 42 as seen in a top view along an optical axis of the optical element 1.

Whereas in the exemplary embodiments of FIGS. 1 to 6 two first actuators 51 connect the top shaper 31 with the bottom shaper 32, in FIG. 7 the top shaper 31 and the bottom shaper 32 are connected with each other by one first actuator 51 and one first resetting element 61.

In FIG. 7, the two first actuators 51 for tilting the first window 21 are arranged on the opposite side of the prism. The two first resetting elements 61 for tilting the first window 21 in the third counter direction are arranged on the opposite side of the prism, too. Having the first actuators 51 and the first resetting elements 61 on both sides (protagonist and antagonist) of the first tilting axis 81 allow for a fast response time since only contraction (heating) of the Shape Memory Alloy is fast and the elongation (cooling) is slow.

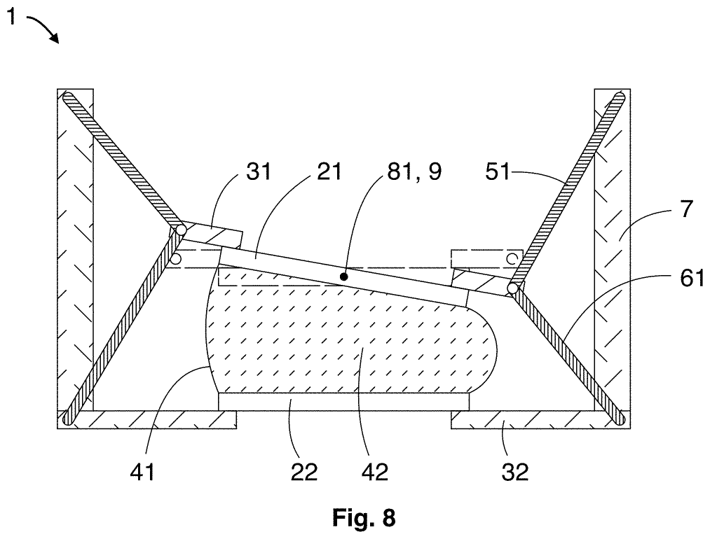

The exemplary embodiment in FIG. 7 comprises a mount 7, which is in particular a Printed Circuit Board. The mount 7 in FIG. 7 is extensively connected to the bottom shaper. To the top shaper 31, the mount 7 is connected by one first actuator 51 and one first resetting element 61. FIG. 8 shows the exemplary embodiment of an optical element 1 of FIG. 7 in a schematic sectional view, in which the first window 21 is tilted. This exemplary embodiment having a first window 21, a second window 22 and a membrane 41 comprises a sealed volume 42, which is deformed. The deformation of the sealed volume 42 has been taken place due to tilting the first window 21 with respect to the second window 22 around a first tilting axis 81 in a first direction. The first tilting axis 81 extends parallel to a main extension plane of the first window 21 and along a first geometric axis 91, through a center point 9, of the sealed volume 42 as seen in a top view along an optical axis of the optical element 1.

The tilting of the first window 21 in the embodiment of FIG. 8 has been taken place by two first actuators 51. Each of the two first actuators 51 has the shape of a wire and comprises the Shape Memory Alloy. By supplying current, each of the two first actuators 51 has been heated to 80° C., preferably to 90° C. At a temperature of 80° C., preferably 90° C., each of the first actuators 51 had reached its transition temperature. Once the transition temperature has been exceeded each of the first actuators 51 has started to contract. Each of the first actuators 51 has been contracted along its main extension direction by at least 2%, preferably by at least 3%.

The heating of the first actuators 51 leads to a protagonistic force, which tilts the first window 21 around the first tilting axis 81 in a first direction. The embodiment of the optical element 1 in FIG. 8 as well as in FIG. 7 comprises two first resetting elements 61. Each of the two first resetting elements 61 comprises the antagonistic force and is arranged to tilt the first window 21 in a third counter direction with the third counter direction being opposed to the first direction. When the first window 21 is tilted as needed, the two first actuators 51 cool down deceeding their transition temperatures. After the two first actuators 51 have been cooled down or while the two first actuators 51 have been cooling down the two first resetting elements 61 have tilted the first window 21 in the third counter direction with the third counter direction being opposed to the first direction.

Each of the two first resetting elements 61 comprises the Shape Memory Alloy and has the shape of a wire, so the transition temperature is reached by 80° C., preferably by 90° C. At this temperature each of the first resetting elements 61 starts to change its phase and contracts. The contraction leads to tilting the first window 21 in the third counter direction. The heating is provided by supplying current to each of the two first resetting elements 61.

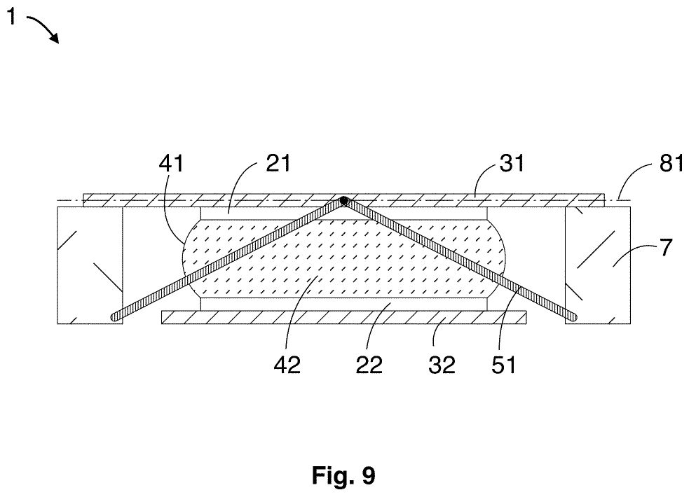

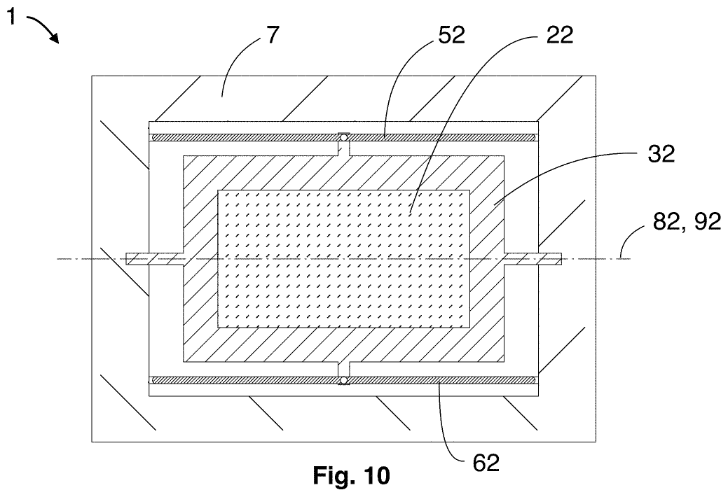

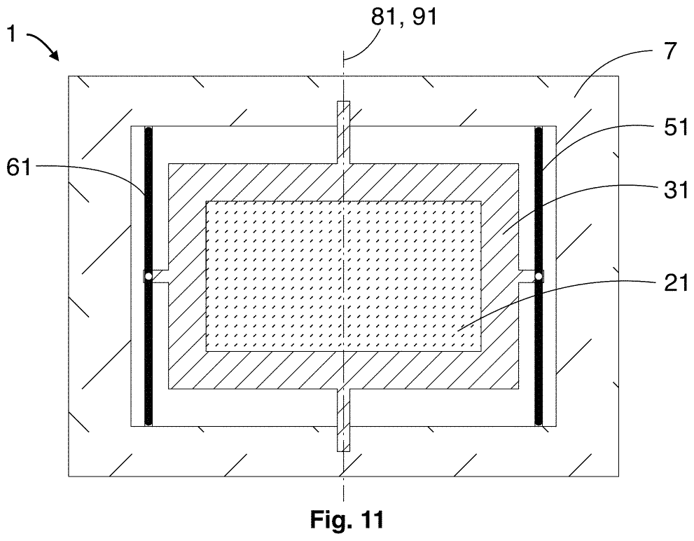

FIGS. 9, 10 and 11 show another exemplary embodiment of an optical element 1. FIG. 9 shows the embodiment in a schematic sectional side view. FIG. 10 shows the embodiment in a schematic sectional bottom view. FIG. 11 shows the embodiment in a schematic sectional top view. The exemplary embodiment shown in FIGS. 9, 10 and 11 comprises a first window 21, a second window 22 and a membrane 41, which, all three, enclose a sealed volume 42. The embodiment comprises two first actuators 51 to tilt the first window 21 around a first tilting axis 81 in a first direction. The embodiment comprises two first resetting elements 61 to tilt the first window 21 in a third counter direction with the third counter direction being opposed to the first direction, shown in FIG. 11. Further, the embodiment comprises two second actuators 52 to tilt the second window 22 around a second tilting axis 82 in a second direction. The embodiment comprises two second resetting elements 62 to tilt the second window 22 in a fourth counter direction with the fourth counter direction being opposed to the first direction, shown in FIG. 10.

Whereas in the exemplary embodiments of FIGS. 1 to 6 the first tilting axis 81 extends parallel to a main extension plane of the first window 21 and through a first attachment point 33 of the first actuator 51 to a top shaper 31, the first tilting axis 81 of the embodiment in FIGS. 9, 10 and 11 extends parallel to a main extension plane of the first window 21 and along a first geometric axis 91 of the sealed volume 42 as seen in a top view along an optical axis of the optical element 1, shown in FIG. 11. The second tilting axis 82 of the embodiment in FIGS. 9, 10 and 11 extends parallel to a main extension plane of the second window 22 and along a second geometric axis 92 of the sealed volume 42 as seen in a top view along an optical axis of the optical element 1, shown in FIG. 10.

The second tilting axis 82 extends obliquely with respect to the first tilting axis 81. In FIGS. 9-11, the second tilting axis 82 extends 90° with respect to the first tilting axis 81. In FIGS. 9-11, the first tilting axis 81 is associated with the axis for the x-tilt and the second tilting axis 82 is associated with the axis for the y-tilt. Hence, the first window 21 is arranged to tilt around the x-axis and the second window 22 is arranged to tilt around the y-axis. Alternatively, the first tilting axis 81 is associated with the axis for the y-tilt and the second tilting axis 82 is associated with the axis for the x-tilt leading to an arrangement for the first window 21 to tilt around the y-axis and for the second window 22 to tilt around the x-axis.

Whereas in the FIGS. 7 and 8 the two first actuators 51 for tilting the first window 21 are arranged on the opposite side of the prism, in FIGS. 9-11 the two first actuators 51 for tilting the first window 21 are arranged on the same side of the prism, shown in FIG. 11. The two second actuators 52 for tilting the second window 22 are arranged on the same side of the prism, shown in FIG. 10. Whereas in FIG. 7 the two first resetting elements 61 for tilting the first window 21 in the third counter direction are arranged on the opposite side of the prism, in FIGS. 9-11 the two first resetting elements 61 for tilting the first window 21 in the third counter direction are arranged on the same side of the prism, shown in FIG. 11. The two second resetting elements 62 for tilting the second window 22 in the fourth counter direction are arranged on the same side of the prism, shown in FIG. 10.

The embodiment in FIGS. 9-11 comprises a mount 7, which is in particular a Printed Circuit Board. The mount 7 is connected to the two first actuators 51, connected to the two first resetting elements 61, connected to the two second actuators 52 and connected to the two second resetting elements 62. The mount 7 provides two bearings for the top shaper 31 to define the first tilting axis 81, indicated in FIG. 11. The mount 7 provides two bearings for the bottom shaper 32 to define the second tilting axis 82, indicated in FIG. 10.

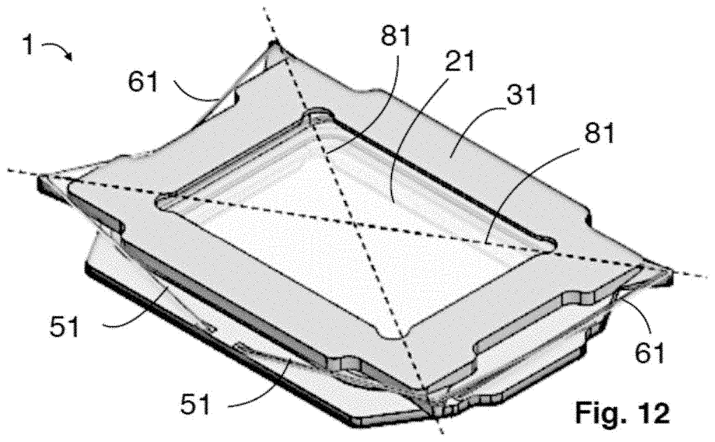

FIG. 12 shows another exemplary embodiment of an optical element 1 in a schematic sectional view. The embodiment in FIG. 12 comprises a first window 21, a second window 22 and a membrane 41, which, all three, enclose a sealed volume 42. The embodiment in FIG. 12 comprises two first actuators 51 to tilt the first window 21 around one first tilting axis 81 and two first actuators 51 to tilt the first window 21 around another first tilting axis 81. The embodiment comprises two first resetting elements 61 to tilt the first window 21 in one third counter direction and two first resetting elements 61 to tilt the first window 21 in another third counter direction.

The one first tilting axis 81 extends parallel to a main extension plane of the first window 21 and through one first attachment point 33 of the first actuator 51 to a top shaper 31. The other first tilting axis 81 extends parallel to a main extension plane of the first window 21 and through another first attachment point 33 of the first actuator 51 to a top shaper 31. The one first tilting axis 81 extends obliquely with respect to the other first tilting axis 81.

The invention is not restricted to the exemplary embodiments by the description based on these. Rather, the invention encompasses every new feature and every combination of features, which in particular includes every combination of features in the patent claims, even if this feature or this combination itself is not explicitly specified in the patent claims or exemplary embodiments.

### LIST OF REFERENCE SIGNS

1 Optical element

21 First window

22 Second window

31 Top shaper

32 Bottom shaper

33 First attachment point

34 Second attachment point

41 Membrane

42 Sealed volume

51 First actuator

52 Second actuator

61 First resetting element

62 Second resetting element

63 Third resetting element

64 Resetting magnet

65 Resetting spring

7 Mount

81 First tilting axis

82 Second tilting axis

9 Center point

91 First geometric axis

92 Second geometric axis

1. Optical element (1) comprising a first window (21) and a second window (22), wherein the first window (21) is connected to the second window (22) by an elastic membrane (41) such that the first window (21), the second window (22) and the membrane (41) enclose a deformable, sealed volume (42), which is filled with a fluid, wherein at least one first actuator (51) is arranged to tilt the first window (21) with respect to the second window (22) around a first tilting axis (81) in a first direction, wherein the first actuator (51) comprises a Shape Memory Alloy and has the shape of a wire.

2. Optical element (1) according to claim 1, wherein at least one first resetting element (61) comprises the Shape Memory Alloy and has the shape of a wire, wherein the first resetting element (61) is arranged to tilt the first window (21) in a first counter direction, wherein the first counter direction is opposed to the first direction.

3. Optical element (1) according to claim 1, wherein the first tilting axis (81) extends parallel to a main extension plane of the first window (21) and either along a first geometric axis (91) of the sealed volume (42) as seen in a top view along an optical axis of the optical element (1), or through a first attachment point (33) of the first actuator (51) to a top shaper (31), wherein the top shaper (31) is connected to the first window (21).

4. Optical element (1) according to claim 1, wherein at least one second actuator (52) is arranged to tilt the second window (22) with respect to the first window (21) around a second tilting axis (82) in a second direction, wherein a second actuator (52) comprises the Shape Memory Alloy and has the shape of a wire.

5. Optical element (1) according to claim 4, wherein at least one second resetting element (62) comprises the Shape Memory Alloy and has the shape of a wire, wherein the second resetting element (62) is arranged to tilt the second window (22) in a second counter direction, wherein the second counter direction is opposed to the second direction.

6. Optical element (1) according to claim 4, wherein the second tilting axis (82) extends obliquely with respect to the first tilting axis (81) and along a main extension plane of the second window (22) and either along a geometric axis (91) of the sealed volume (42) as seen in a top view along an optical axis of the optical element (1) or through a second attachment point (34) of the second actuator (52) to a bottom shaper (32), wherein the bottom shaper (32) is connected to the second window (22).

7. Optical element (1) according to claim 1, wherein a third resetting element (63) is arranged to tilt the first window (21) in a third counter direction, wherein the third counter direction is opposed to the first direction and/or is arranged to tilt the second window (22) in a fourth counter direction, wherein the fourth counter direction is opposed to the second direction, wherein the third resetting element (63) comprises at least one of the following:
the elastic membrane (41),
at least one resetting spring (65),
at least one resetting magnet (64).

8. Optical element (1) according to claim 3, wherein a mount (7) provides at least one first bearing for the top shaper (31) to define the first tilting axis (81), and/or provides at least one second bearing for the bottom shaper (32) to define the second tilting axis (82).

9. Optical element (1) according to claim 6, wherein the top shaper (31) and the bottom shaper (32) are connected by the first actuator (51) or by the second actuator (52).

10. Method for operating an optical element (1) according to claim 1, wherein
a Shape Memory Alloy of at least one first actuator (51) is heated up by supplying current,
once a transition temperature is reached, the first actuator (51) contracts, and
the contraction tilts the first window (21) with respect to the second window (22) around a first tilting axis (81) in a first direction.

11. Method according to claim 10, wherein
a Shape Memory Alloy of at least one second actuator (52) is heated up by supplying current,
once a transition temperature is reached, the second actuator (52) contracts, and
the contraction tilts the second window (22) with respect to the first window (21) around a second tilting axis (82) in a second direction.

12. Method according to claim 10, wherein the transition temperature of the first actuator (51) is 80° C., preferably 90° C., wherein the first actuator (51) contracts along its main extension direction by at least 2%, preferably by at least 3%, and/or wherein the transition temperature of the second actuator (52) is 80° C., preferably 90° C., wherein the second actuator (52) contracts along its main extension direction by at least 2%, preferably by at least 3%.

13. Method according to claim 10, wherein
the first actuator (51) cools down deceeding the transition temperature, and
a third resetting element (63) tilts the first window (21) in a third counter direction with the third counter direction being opposed to the first direction, and/or
the second actuator (52) cools down deceeding the transition temperature,
the third resetting element (63) tilts the second window (22) in a fourth counter direction with the fourth counter direction being opposed to the second direction.

14. Method according to claim 10, wherein
the first actuator (51) cools down deceeding the transition temperature,
a Shape Memory Alloy of a first resetting element (61) is heated up by supplying current,
once a transition temperature is reached, the first resetting element (61) contracts, and
the first resetting element (61) tilts the first window (21) in a first counter direction with the first counter direction being opposed to the first direction, and/or
the second actuator (52) cools down deceeding the transition temperature,
a Shape Memory Alloy of a second resetting element (62) is heated up by supplying current,
once a transition temperature is reached, the second resetting element (62) contracts, and
the second resetting element (62) tilts the second window (22) in a second counter direction with the second counter direction being opposed to the second direction.
